(19) United States
(12) Patent Application Publication
(10) Pub. No.: US 2026/0037558 A1
(43) Pub. Date: Feb. 5, 2026

(54) SYSTEM AND METHOD FOR EXPERT-ASSISTED GENERATIVE AI PROMPT RESPONSE ADAPTATION

(71) Applicant: Rhodes Financial Services, LLC, Augusta, GA (US)

(72) Inventors: Christopher Savage, Grovetown, GA (US); Peter Mourfield, Augusta, GA (US)

(21) Appl. No.: 19/282,176

(22) Filed: Jul. 28, 2025

Related U.S. Application Data
(60) Provisional application No. 63/678,856, filed on Aug. 2, 2024.

(51) Int. Cl. G06F 16/334; G06F 16/22

(52) U.S. Cl. CPC G06F 16/334; G06F 16/2237

(57) ABSTRACT

A system and method for expert-assisted generative AI prompt response adaptation within a computer-populated environment includes a user interface for enabling a user to pose and send user queries and display answers to the user query. A bot answer system is configured to retrieve relevant context in response to the user query. A generative model is configured to provide answers upon the user interface based on retrieved relevant context data in response to the user query. A feedback integration system is configured to provide subject matter expert feedback on at least one of the user query and the answer in real-time. The bot answer system and the feedback integration system are partitioned from one another and direct partitioned data flows through a convergent embedding creation process for storing embeddings in a vector database supporting a knowledge base. The subject matter expert feedback ensures continual improvement of a knowledge base.

### PRIOR HISTORY

This patent application is based on and claims the benefit of U.S. Provisional Patent Application No. 63/678,856 filed in the United States Patent and Trademark Office on 2 Aug. 2024, the specifications and drawings of which are incorporated by reference herein in their entirety.

### BACKGROUND OF THE INVENTION

### Field of the Invention

The present invention generally relates to a system and method for adapting informational responses produced by GenAI software with human feedback and more particularly to collaborative artificial intelligence whereby one or more subject matter experts interface with the system to update and refine query responses within an ever-evolving and oftentimes complex topical field of inquiry.

### BRIEF DESCRIPTION OF THE PRIOR ART

US Patent Application Publication No. 2018/0005288 authored by Delaney describes a certain methodology for determining that chat texts provided in a chat session by first and second chat application instances are directed to negotiation of a sale of an item. A recommended sale price for the item is generated based on the chat texts and item's current price. In response to determining to provide the recommended sale price to the first chat application instance, a third chat text can be transmitted, via the chat bot, to the chat session to cause a first UI of a user device hosting the first chat application instance to present the recommended sale price, and to cause the first UI to present a request for selection, from the first chat application instance, whether to transmit a fourth chat text to cause, in a second UI of a user device hosting the second chat application instance, a presentation of the recommended sale price.

US Patent Application Publication No. 2020/0265116 authored by Chatterjee et al. describes a user intent identification system and method for identifying user intent from user statements. The user intent identification system receives input statement provided by a user from a Natural Language Understanding (NLU) engine. The input statement is processed to remove one or more irrelevant content. A plurality of features for each word in the processed input statement is extracted. The plurality of features comprises Parts of Speech (POS) label, dependency parse tree and word embeddings. The user intent determination system predicts class for each word in the processed input statement from a plurality of predefined classes using a neural network model. The neural network model predicts class for each word based on input vector generated for each word based on the plurality of features. Thereafter, the user intent is identified based on class predicted for each word in processed input statement.

US Patent Application Publication No. 2021/0141820 authored by Vora et al. describes a method for generating a personalized response to a user query. An omnichannel assistant receives a query from a user. The query is parsed to identify a user request. A user profile of the user is analyzed to determine one or more sources for responding to the query. The user profile includes a set of trusted sources for the user. Data for responding to the query is retrieved from the one or more sources. A channel for a response is selected based at least in part on the user profile. The response to the query is generated. The response is generated using the retrieved data, the selected channel, and the user profile. The response is then transmitted to the user.

U.S. Pat. No. 11,431,660 issued to Leeds et al. ('660 Patent) discloses a System and Method for Collaborative Conversational AI. The '660 Patent describes an architecture wherein members of the disclosed system participate in collaborative conversations with one or more AI and human “subminds” connected via a forum, including conversing in natural language and facilitated by one or more “facilitators”. CCAI Applications include the creation of widely extensible evolving modular polylogical groups that are capable of collaboration with sentient beings, collaborative control of devices, service worker interfaces, hybrid representations of sentient beings (including via “reconveyance” of conversation segments), in collaborations that may include, exclude or require human or AI participation.

U.S. Pat. No. 12,014,149, issued to Li et al. ('149 Patent) discloses a Multi-Turn Human-Machine Conversation Method and Apparatus Based on Time-Sequence Feature Screening Encoding Module. The '149 Patent describes a process for screening information for each utterance in a historical conversation so as to obtain semantic information only relevant to candidate responses and how to reserve and extract time-sequence features in the historical conversation, thus improving prediction accuracy of a multi-turn human-machine conversation system. The adopted technical scheme is as follows: S1, acquiring a multi-turn human-machine conversation data set; S2, constructing a multi-turn human-machine conversation model: constructing a multi-turn human-machine conversation model based on the time-sequence feature screening encoding module; and S3, training the multi-turn human-machine conversation model: training the multi-turn human-machine conversation model constructed in S2 on the multi-turn human-machine conversation data set obtained in S1.

### GENERAL DESCRIPTIONS

GenAI tools such as chatbots are commonly used to provide customer support in a variety of industries. When a customer enters a question, the chatbot can provide an automated response either by offering a predefined answer based on specific words or phrases in the user's question, or by using natural language processing and machine learning to analyze the input and provide an appropriate response in real-time.

The GenAI systems that currently exist in the market are built to adapt responses based on user feedback by utilizing automated means (reinforcement learning, for example). Such machine learning techniques mimic human trial-and-error learning processes, but these systems take time and effort to train to a level where the accuracy of responses is deemed acceptable. Reinforcement learning requires significant interaction and iteration with the input to achieve a reliable, accurate output. The state-of-the-art perceives a need for a system and associated methodology configured to enable or allow for human input to improve AI-assisted responses to customer inquiries in real time, ensuring the highest level of accuracy and reliability in the output.

To address this perceived need, the presently disclosed subject matter provides a system whereby a GenAI produces initial responses to prompts. Subject Matter Experts (SMEs) then evaluate and adapt these responses in real time. This process ensures that the AI-generated content is accurate, relevant, and aligned with the specific knowledge domain. Key features of the presently disclosed system include:
Generative AI: Produces initial responses based on prompts.
Real-time Evaluation: SMEs review the AI-generated content as it is flagged by the system.
Adaptation: SMEs modify and/or enhance the AI responses to ensure accuracy and relevance.
Quality Assurance: Combines AI speed and human expertise for accurate results.
Continuous Improvement: Feedback from SMEs is used to refine the AI system over time.

Accordingly, a primary objective of the presently disclosed subject matter is to improve the accuracy and reliability of GenAI-assisted responses to user queries with complex and ever-evolving query environments. This is essentially achieved by the introduction of a feedback integration system into generative artificial intelligence system by allowing Subject Matter Experts to interface with a bot answer system to modify and enhance responses to user queries in real time.

According to one aspect of the presently disclosed subject matter there is a system for expert-assisted generative AI prompt response adaptation within a computer-populated environment. The system comprises a question user interface, a bot answer system, a generative model and a feedback integration system. The question user interface enables a user to pose and send a user query and display an answer to the user query. The bot answer system is configured to retrieve relevant context in response to the user query. The generative model is configured to provide the answer upon the question user interface based on retrieved relevant context data in response to the user query. The feedback integration system is configured to provide subject matter expert feedback on at least one of the user query and the answer, which subject matter expert feedback ensures continual improvement of a knowledge base.

In some embodiments, the bot answer system and the feedback integration system are partitioned from one another and configured to direct partitioned data flows through a convergent embedding creation process. The embedding creation process is configured to vectorize the partitioned data flows and store embeddings in a vector database supporting the knowledge base. In some embodiments, the vector database leverages metadata-driven retrieval, prioritizing source documents based on similarity, recency of updates, and data source, the vector database thereby ensuring the convergent knowledge base is continually updated with relevant and reliable information in support of the answer.

In some embodiments, the feedback integration system is configured to provide subject matter expert feedback in real-time based on at least one of the user query and the answer. In some embodiments, the feedback integration system is configured to provide supervisory subject matter expert review and final approval before the partitioned data flows are vectorized and the embeddings are stored in the vector database for supporting the knowledge base. In some embodiments, the bot answer system is based on and characterized by a retrieval-augmented generation architecture. In some embodiments, the generative model is characterized by a generative pretrained transformer.

In some embodiments, a user feedback mechanism enables the user to provide reactionary feedback in response to the answer. The reactionary feedback is reviewable by a Subject Matter Expert (SME) at a feedback user interface, which feedback user interface enables the Subject Matter Expert to create an SME feedback document. The SME feedback document provides a basis for at least a contextualized query response.

In some embodiments, the feedback integration system enables at least one cycle of supervisory subject matter expert review and modification to at least one of the user query and the answer before returning the contextualized query response to the user query. In some embodiments, the feedback user interface is configured to enable the Subject Matter Expert to review at least one of the user query, the answer, and reactionary feedback and provide subject matter expert feedback in response to any one of the user query, the answer, and the reactionary feedback before the generative model provides the contextual query response upon the user interface.

Supervisory subject matter expert review may be performed by a Subject Matter Expert Champion or SME-C. While a Subject Matter Expert or SME can provide feedback in the form of a feedback document, a Subject Matter Expert Champion or SME-C can provide both feedback and commit feedback documents to the system. Whereas the SME typically operates in real-time to respond to user queries, adjusting GenAI responses as needed, the SME-C typically operates in an asynchronous manner for ensuring accuracy and completeness of query responses before committing the data to the knowledge base. It will be recalled that the system greatly benefits from feedback provided in real-time, rather than experiencing delays for source documents to be updated and reprocessed. Real-time feedback enables the system to quickly address incorrect answers and hallucinations.

According to another aspect of the presently disclosed subject matter there is provided a system for expert-assisted generative AI prompt response adaptation within a computer-populated environment. The system comprises a firstly partitioned source document retrieval system configured to retrieve and periodically update source documents in response to a user query; a generative model configured to provide an answer based on the retrieved and periodically updated source documents in response to the user query, the answer being stored in a first file format; a secondly partitioned feedback integration system configured to provide a subject matter expert feedback document in connection with at least one of the user query and the answer, the subject matter expert feedback document being stored in the first file format; and an embedding creation system configured to vectorize the answer and the subject matter expert feedback document and store embeddings therefrom within a vector database thereby providing a convergent knowledge base from which the answer can be returned to the user in response to the user query.

In some embodiments, the vector database leverages metadata-driven retrieval, prioritizing source documentation based on similarity, recency of updates, and data source. The vector database thereby ensures the convergent knowledge base is continually updated with relevant and reliable information to generate and return the answer. In some embodiments, the feedback integration system is configured to provide subject matter expert feedback in real-time based on at least one of the user query and the answer. In some embodiments, the feedback integration system is configured to provide supervisory subject matter expert review and final approval before the partitioned data flows are vectorized and the embeddings are stored in the vector database for supporting the knowledge base.

In some embodiments, a user feedback mechanism enables the user to provide reactionary feedback in response to the answer. The reactionary feedback is reviewable and answerable within the feedback integration system for providing a contextualized query response. In some embodiments, the feedback integration system enables at least one cycle of supervisory subject matter expert review and modification to at least one of the user query and the answer before returning the contextualized query response to the user query. In some embodiments, a feedback user interface is configured to enable a Subject Matter Expert to review at least one of the user query, the answer, and the reactionary feedback and provide additional subject matter expert feedback in response to any one of the user query, the answer, and the reactionary feedback before the generative model provides the contextual query response.

According to another aspect of the presently disclosed subject matter there is provided a method for expert-assisted generative AI prompt response adaptation within a computer-populated environment, the method comprising the steps of: retrieving source documentation via a data extraction process of a bot answer system; storing the source documentation in a first file format in a relational database or a physical file storage; creating a feedback document in response to at least one of a user query and a query response within the bot answer system; storing the feedback document in the first file format in the relational database or physical file storage; vectorizing the source documentation and the feedback document via an embedding creation process; storing embeddings from the embedding creation process in a vector database thereby providing a vectorized knowledge base; and providing the query response to the user query via a generative model based on the vectorized knowledge base.

In some applications, the method comprises the step of storing metadata corresponding to the source documentation within the vector database, the vector database thereby leveraging metadata-driven retrieval and prioritizing source documentation based on similarity, recency of updates, and data source. In some applications, the method comprises the steps of: providing user feedback in response to the query response; reviewing at least one of the user feedback, the user query and the query response in real-time; and revising at least one of the user query and the query response in real-time thereby providing a revised feedback document or a revised feedback.

In some applications, the method further comprises the steps of then storing the revised feedback in the first file format in the relational database or physical file storage; vectorizing the revised feedback via the embedding creation process after a finally approved answer is compiled; storing embeddings from the revised feedback in the vector database thereby providing an updated knowledge base; and providing a contextualized query response via the generative model based on the updated knowledge base.

In some applications, the method comprises the steps of providing a listing of reviewable content upon a feedback user interface, the feedback user interface being configured to enable a Subject Matter Expert to review any one of the user query, the query response, the user feedback and a precedent contextualized response; revising at least one of the user query, the query response and the precedent contextualized response thereby providing a revised feedback; storing the revised feedback in the first file format in the relational database or physical file storage; vectorizing the revised feedback via the embedding creation process; storing embeddings from the revised feedback in the vector database thereby providing an updated knowledge base; and providing a final contextualized query response via the generative model based on the updated knowledge base.

In some applications, the method comprises the steps of reviewing a precedent contextualized response before outputting a final answer upon a user interface; revising at least one of the user query and the precedent contextualized response thereby providing a revised feedback; storing the revised feedback in the first file format in the relational database or physical file storage; vectorizing the revised feedback via the embedding creation process; storing embeddings from the revised feedback in the vector database thereby providing an updated knowledge base; and providing a final contextualized query response via the generative model based on the updated knowledge base.

### BRIEF DESCRIPTIONS OF THE DRAWINGS

Other features and objectives of the presently disclosed subject matter will become more evident from the following brief descriptions of patent drawings.

FIG. 1 is a flowchart diagram depicting a simplified initial load sequence or data extraction process according to the presently disclosed subject matter.

FIG. 2 is a flowchart diagram of an embedding creation process according to the presently disclosed subject matter.

FIG. 3A is a first flowchart diagram portion of a more complex initial load sequence or data extraction process according to the presently disclosed subject matter.

FIG. 3B is a second flowchart diagram portion of the more complex initial load sequence or data extraction process stemming from the first flowchart diagram portion otherwise depicted in FIG. 3A.

FIG. 4 is a flowchart diagram of a source document updating process according to the presently disclosed subject matter.

FIG. 5 is a flowchart diagram of a simple user interaction process according to the presently disclosed subject matter.

FIG. 6 is a flowchart diagram of complex user interaction process according to the presently disclosed subject matter.

FIG. 7 is a flowchart diagram of a feedback user interface process according to the presently disclosed subject matter.

FIG. 8 is a firstly formatted flowchart diagram of a dashboard user interface flow or process according to the presently disclosed subject matter.

FIG. 9 is a secondly formatted flowchart diagram of a dashboard user interface flow or process according to the presently disclosed subject matter.

FIG. 10 is an array of flow chart diagrams depicting a full system flow according to the presently disclosed subject matter.

FIG. 11 is a sample screenshot of a Support Bot Question and Answer session with Support Agent Feedback according to the presently disclosed subject matter.

### DETAILED DESCRIPTIONS

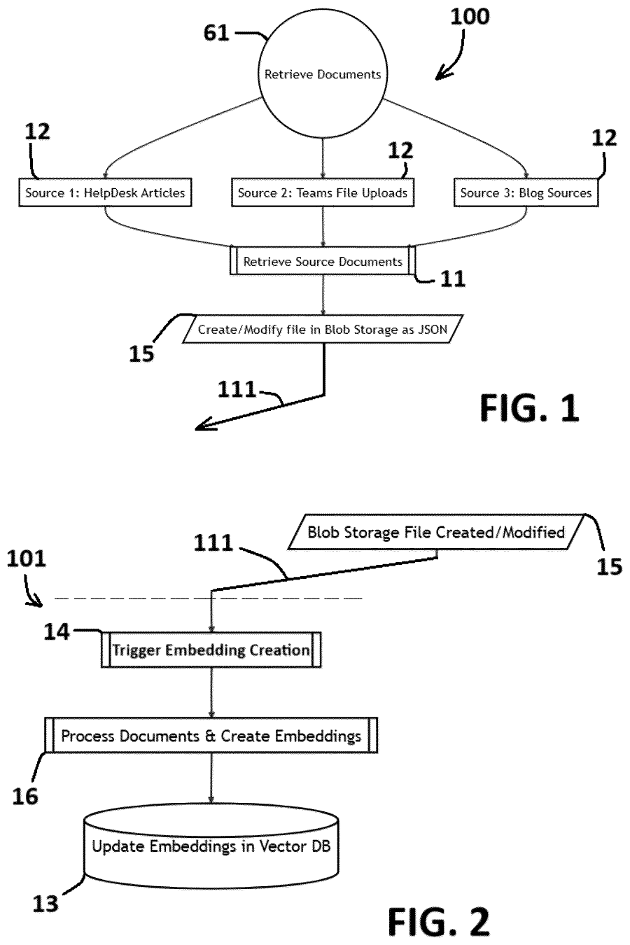

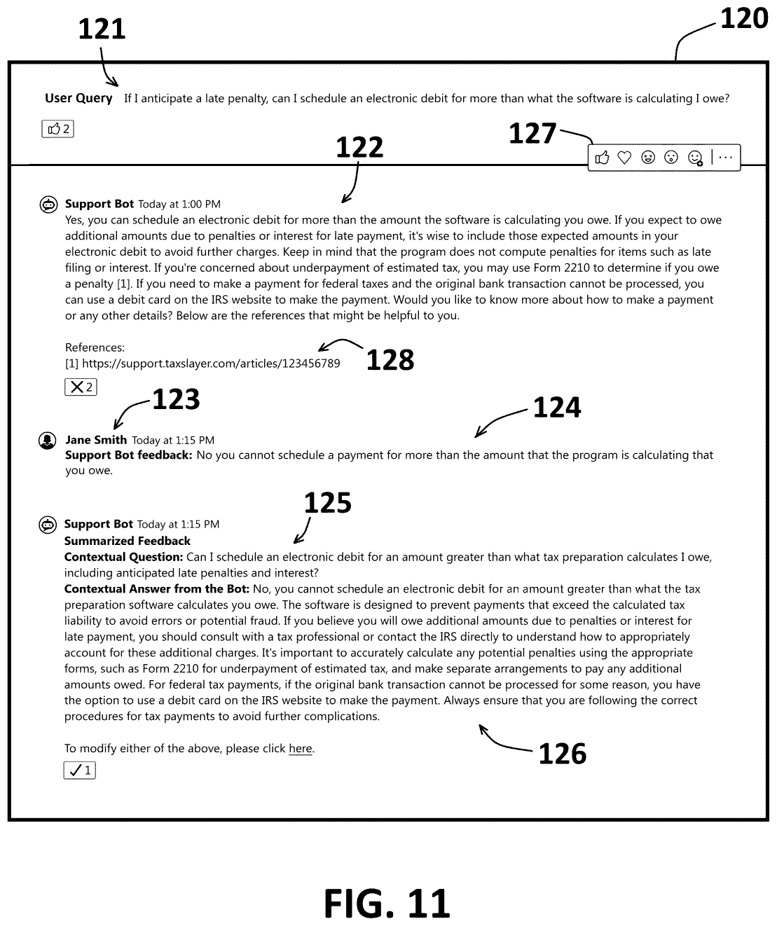

Referring now to the drawings with more specificity, the following specifications generally describe a system and method for expert-assisted generative Artificial Intelligence (AI) prompt response adaptation within a computer-populated environment. Comparatively referencing FIGS. 1-10, the reader will there consider the overall flows and sequencing of the presently disclosed subject matter. FIG. 11 depicts a sample question-answer session or exchange in the context of an exemplary tax preparation software environment. The system and method according to the presently disclosed subject matter operates within a computer driven environment outfitted with non-transitory computer implementable software-based components allowing communication between computers within the computer network configured to allow expert-assisted generative AI prompt response adaptation.

Generative Artificial Intelligence or GenAI refers to a type of artificial intelligence that can create new content by learning patterns from existing data. GenAI uses sophisticated machine learning models, such as deep learning models, to generate new and original content. In some applications, the system for expert-assisted generative Artificial Intelligence (AI) prompt response adaptation may be characterized by a Retrieval-Augmented Generation (RAG) architecture for supporting a Bot Answer System (BAS). In the context of Artificial Intelligence or AI, Retrieval-Augmented Generation (RAG) is a technique that enhances large language models (LLMs) by providing them with access to external knowledge sources before generating a response. Instead of relying solely on the LLM's pre-trained knowledge, RAG allows it to retrieve relevant information from databases, documents, or the web, and incorporate this information into its answer. This approach leads to more accurate, up-to-date, and contextually relevant support bot responses/answers.

It is noted LLMs are trained on vast amounts of text data, but their knowledge is essentially frozen at the time of training. This means they may not be aware of new information or specific details relevant to a user's query. The RAG architecture overcomes this limitation by incorporating a retrieval component into the LLM pipeline. This component searches for relevant information from external sources based on the user's query. The retrieved information is then combined with the user's query and fed into the LLM, which uses this augmented context to generate a more informed and accurate response.

The RAG architecture thereby offers several advantages, including increased accuracy, reduced hallucinations, improved context, and cost effectiveness. More particularly, LLMs can access the most up-to-date and relevant information, thereby reducing the likelihood of outdated or inaccurate responses. By grounding the LLM in external knowledge, RAG can minimize the chances of the model generating false or misleading information. Further, LLMs are enabled to understand and respond to specific queries with greater context and nuance. RAG can be a relatively more cost-effective way to provide LLMs with access to new information, as it avoids the need for continuous retraining.

In some embodiments, a generative model is configured to provide answers to user queries based on retrieved relevant context data in response thereto. In some embodiments, the generative model may be characterized by a Generative Pre-trained Transformer or GPT model supported by OpenAI. Generative Pre-Trained Transformer or GPT models can generate new text, meaning they can create content like articles, stories, or code, rather than just analyzing or classifying existing text. These GPT models are trained on massive amounts of text data, allowing them to learn patterns and relationships in language. This pre-training allows them to be effective on a wide range of tasks without needing to be retrained from scratch for each specific task. Further, GPT models use the transformer architecture, a type of neural network architecture that has proven particularly effective for natural language processing tasks. The GPT model may thus power an AI application for understanding and creating text or conversation.

In some embodiments, the RAG architecture according to the presently disclosed subject matter uses Cloud Storage, Vector Databases, Relational Databases, Web Application Programming Interfaces (APIs), Cloud Function Applications (Apps), Model-View-Control (MVC) Web Sites and Teams Bot API to retrieve and create source documents. In this regard, the reader is initially directed to FIG. 1. Referencing FIG. 1 the reader will consider a simplified initial load sequence or flow detailing a data polling or data extraction process 100. Once document retrieval is initiated as at initialization symbol 61, a number of source documents 11 are retrieved from a number of relevant documents 12. As exemplified in the drawing support in FIG. 1, the relevant sources 12 may include, but not be limited by, helpdesk articles, teams file uploads, and/or blog sources. The retrieved source documents 11 are then stored in blob storage in JavaScript Object Notation (JSON) format for data interchange as at input/output box 15.

Blob storage is a cloud storage solution for unstructured data, often referred to as Binary Large Objects (BLOBs). It is designed to store massive amounts of data, including text, images, audio, video, and other binary files, without a predefined structure or format excels at storing data that does not fit neatly into traditional database structures, like tables or rows. Blob storage is a type of object storage, where data is accessed via a unique identifier (object name) rather than through a hierarchical file system. Blob storage systems are cost-effective and designed to handle large amounts of data that are accessible from anywhere with an internet connection.

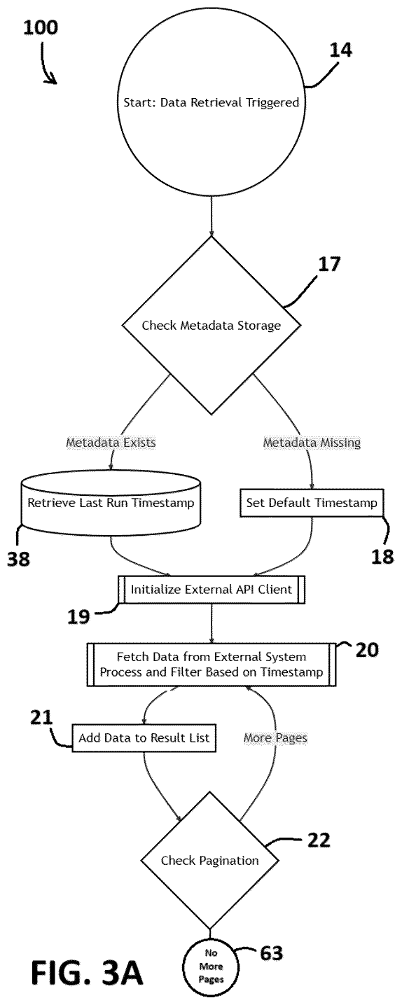

JavaScript Object Notation or JSON is a lightweight data-interchange format used for transmitting data between a server and a web application. It is text-based, human-readable, and relatively easy for machines to parse. In this regard, the source documents 11 are structured text-based documents detailing real-world information, and in some applications are focused on topical areas of inquiry that benefit from expert oversight and input. The source documents 11 are then vectorized by way of an embedding creation process 101 and saved in a vector database 13 as generally depicted in FIG. 2. The vector database 13 is a data source used to quickly manage and search vector data. Put simply textual data is changed into vector data by way of the embedding creation process 101. Directing the source documents 11 into JSON files allows the system to decouple the vectorization process from the data mining process, enabling different teams to work on these workflows independently.

It is noted machine learning algorithms operate on numerical data, so textual data must be converted into a numerical format for machines to learn patterns and make predictions. Vectorization techniques capture the semantic meaning and contextual relationships between words, enabling models to understand the nuances of language. Textual data can be complex and varied. Vectorization transforms this complex and varied data into a manageable, fixed-size numerical form, reducing complexity for analysis and modeling. Vectorization is fundamental for advanced natural language processing tasks such as sentiment analysis, named entity recognition, and information retrieval.

The vector data may be referred to as embeddings that represent real-world words or text in a form that machine learning models can easily process and are created via the embedding creation process as at subroutine symbol 16 once data extraction occurs and the vector database 13 is updated. Metadata for the source of the documents is stored along with timestamp information for the retrieved data. Noting that the vector database 13 is essentially a data source used to quickly manage and search data, the textual data from the source documents 11 is vectorized into embeddings by the embedding creation process, specifically at subroutine 16 for ease of reference and use by the system according to the presently disclosed subject matter.

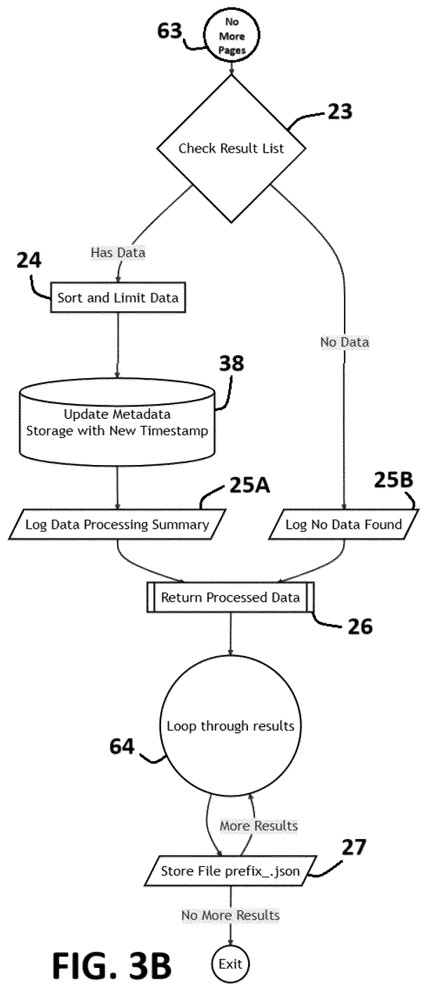

Turning now to FIGS. 3A and 3B, the flow there depicted covers two pages connected by a “No New Pages” connector symbol 63. Together referencing FIGS. 3A and 3B the reader will consider a relatively more detailed or expanded data extraction process 100. The data extraction process or function 100 according to the presently disclosed subject matter periodically checks for or requests data from a server or source to create a source document 11. Given this periodicity, the data extraction process 100 is periodically triggered and in some applications, the data extraction process 100 is triggered by a timer trigger 14 that runs every “N” number of minutes.

Metadata availability is first checked as at query symbol 17. If metadata exists, the last run timestamp is retrieved from a relational database 38 or physical file storage. One example of a relational database is a Structured Query Language or SQL database. A SQL Database is a relational database that organizes structured sets of data in a tabular form with columns and rows and is compiled using Structured Query Language (SQL). In some embodiments, Structured Query Language is the standard language used for creating, storing, updating, retrieving, and managing data within the physical file storage or relational database 38. These SQL databases excel at storing and managing structured data, where the relationships between data points are clearly defined.

If metadata is missing, a default timestamp is set as at process symbol 18. An external API client is then initialized as at subroutine symbol 19 and data is fetched from an external system process and filtered based on timestamp data as at subroutine box 20. In other words, the system communicates with the data source and uses metadata from storage if available to ensure incremental updates. In this regard, it is noted the metadata holds data required to determine where to pick up (e.g. last_run:<date>). Fetched data is then added to a paginated results listing as at process symbol 21. If additional pages are present as at check pagination query symbol 22, additional data is added to the results listing via subroutine 20.

If there are no additional pages present (as at connector symbol 63), the results listing is checked as at check result list query symbol 23 in FIG. 3B. If the results listing check returns data, the data is sorted and limited as at process symbol 24 and the relational database 38 is updated with metadata having the updated timestamp and a log of the data processing summary is created as at input/output symbol 25A. If the results listing check returns no data, a no data log is created as at input/output symbol 25B. Each step logs its progress for the purpose of monitoring and debugging. Processed data is then returned as at subroutine symbol 26 and stored as structured JSON files as at input/output symbol 27, looping through results as at 64. In some embodiments, the JSON files may be named as prefix_<id> where the prefix is a known name for the source file. The process 100 ends after successfully storing the data and logging the completion.

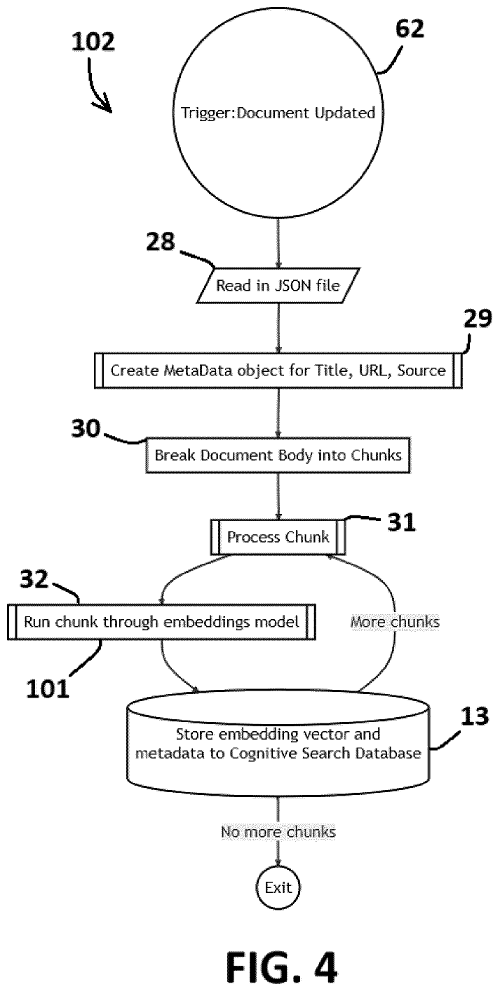

Referencing FIG. 4, the reader will consider a document updating process 102 according to the presently disclosed subject matter, which process 102 initializes when a source document is updated as at initialization symbol 62. A source document 11 stored in the relational database 38 is read in JSON file format as at input/output box 28 and metadata is created for the document title, Uniform Resource Locator or URL for the document and document source as at subroutine 29 whereafter the document body of the source document 11 is broken into chunks according to any of a number of known chunking strategies of Retrieval-Augmented Generation as at process symbol 30. The individual chunks are then processed as at subroutine symbol 31 by running individual chunks through an embeddings subroutine 32 whereafter the embedding vectors and metadata are saved to the vectorized cognitive search database 13.

The foregoing generally details relatively state-of-the art techniques for bot answer systems. Central to the practice of the system and method for expert-assisted generative Artificial Intelligence (AI) prompt response adaptation within a computer-populated environment is a feedback integration process or system, which allows users and subject matter experts to provide feedback on returned answers to user queries. In some applications, this feedback is provided in real-time rather than waiting for source documents to be updated and reprocessed. Providing a real-time human feedback loop is beneficial as it enables the system to quickly address incorrect generative artificially intelligent (GenAI) answers and hallucinations. This feedback is seamlessly incorporated into the system through Subject Matter Expert or SME review and subsequent updates to the embeddings, thereby ensuring continual improvement and accuracy of the vectorized knowledge base stored within the vector database 13. The knowledge base as stored within the vector database 13 is compiled by way of convergent data flows, including source document retrieval and associated source document updates from a first partition or side of the system and feedback document flows from a second partition or side of the system.

The feedback document flow is based on the source document flows and derives from human subject matter expert feedback having expertise in the topical field that the source documents cover. In some applications, this subject matter expert feedback is provided in real-time and provided by way of a feedback document. A feedback document is akin to a source document with the primary difference between the two types of documents being that the feedback document originates from feedback from a Subject Matter Expert or SME as opposed to more generalized real-world information provided by GenAI or BAS. In some applications, the bot answer system and real-time overview by subject matter experts in the field of inquiry may occur in the context of tax preparation software, for example. Notably, the tax environment is an exemplary topical field of inquiry as laws and regulations tend to continually evolve and are generally considered complex in nature. Surveillance of source document accuracy within a bot answer system environment is highly useful and can be bolstered by human oversight as accessed through either a dashboard user interface or a separate feedback user interface of the system.

In other words, source documentation within a bot answer system or RAG environment will require periodic updates as the environment evolves and can greatly benefit from human oversight and periodic correction of AI-generative responses. The system and method for expert-assisted generative Artificial Intelligence (AI) prompt response adaptation requires Subject Matter Experts or SMEs to at least periodically review and update GenAI outputs to ensure accuracy and reliability of the vectorized knowledge base stored within the vector database 13. Notably, feedback documents deriving from SMEs and source documents deriving from GenAI sources are convergently directed into the vector database 13 through the embedding creation process 101. This approach leads to more accurate, up-to-date, and contextually relevant support bot responses/answers.

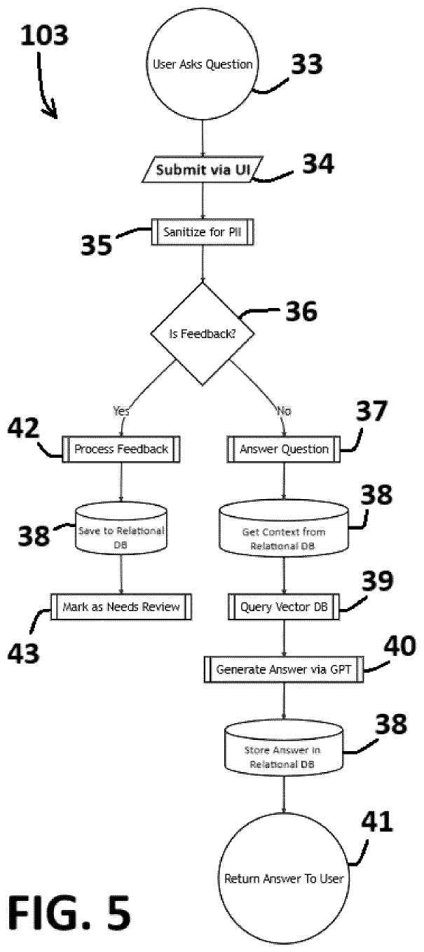

Referencing FIG. 5, the reader will consider a simplified user interaction flow chart diagram or process as at 103. The process 103 starts with a user query as at initialization symbol 33. The user query is submitted to a bot answer system of the RAG via a question user interface as at input/output symbol 34 whereafter the user query and any data associated therewith may be sanitized for personally identifiable information as at subroutine symbol 35. If there is no feedback for the submitted user query as at query symbol 36, the process follows an answer question subroutine track as at subroutine symbol 37. The bot answer system summarizes the user query with a Generative Pre-trained Transformer (GPT) model in some embodiments and obtains context from the relational database as at database symbol 38 and searches the vector database 13 for relevant data as at subroutine symbol 39.

In some applications, the system accesses the top three vectorized source documents 11 from the vector database 13 based on most recently updated timestamps, which source documents may have been previously updated by subject matter expert feedback. In other words, this is the point in the process where subject matter expert feedback overwrites old context. The GPT model then summarizes the vectorized source documents 11 and generates an answer as at subroutine symbol 40, storing the answer into the relational database 38 for future feedback and returns the answer or query response to the question user interface and the user as at symbol 41.

In some applications, the user may then provide feedback in the form of a positive (e.g. a thumbs up icon) or a negative (e.g. a thumbs down icon) for answer accuracy thereby providing user feedback, which user feedback may be processed as at subroutine symbol 42 and the user reaction/feedback is sent back to the bot answer system to be stored or saved in the relational database 38. In some embodiments, the user feedback may be flagged as needing review as at subroutine 43 as, for example, if the user reacts negatively or the query response appears to be incorrect from the user's point of view.

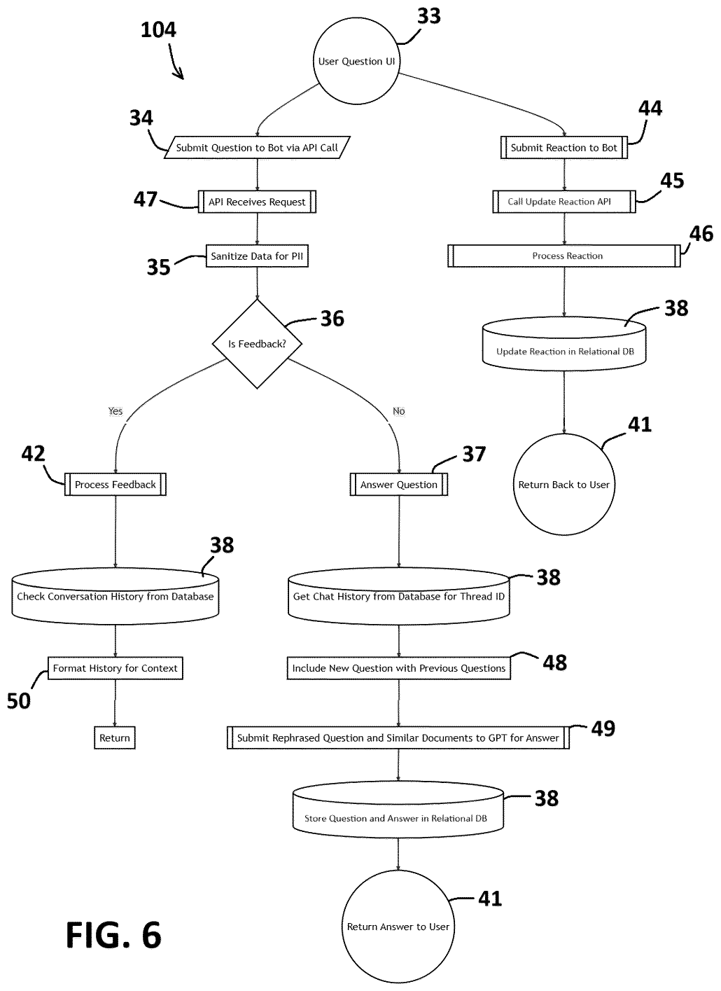

Referencing FIG. 6, the reader will consider a more detailed or expanded user interaction flow chart diagram or process as at 104. The user submits the positive or negative reaction to the bot answer system as at subroutine symbol 44 whereafter the reaction type may be updated through a program via a Call Update Reaction API subroutine 45 and a Process Reaction subroutine 46 before being stored or saved in the relational database 38 and returned to user as at symbol 41. The subject matter expert may access the question user interface feedback channel/section detailed above and forward the data there found to the question user interface whereafter the data extraction process 100 scans for new feedback on a timer interval, creating a new source document 11 and storing that new source document file 11 in the relational database 38. After a final review determines the new source document 11 is fully accurate and complete, the embedding creation process 101 may then vectorize that new or updated source document 11 file as generally depicted in FIGS. 2 and 4.

In some applications, an initial user query 33 is submitted to a bot answer system of the RAG via an application programming interface (API) call as at input/output symbol 34 whereafter the user query and any data associated therewith is received by the API as at subroutine symbol 47 and sanitized for any personally identifiable information as at subroutine symbol 35. If there is no feedback for the submitted user query as at query symbol 36, the process follows an answer question subroutine track as at subroutine symbol 37. In some applications, the bot answer system retrieves a chat history from the relational database 38 for a thread identification whereafter the new question is included with previous questions to provide a rephrased query as at process symbol 48. The rephrased query and similar documents are submitted to the GPT model for an answer as at subroutine symbol 49. The rephrased query and the answer are stored or saved in the relational database 38 and the answer is returned to the user as at symbol 41.

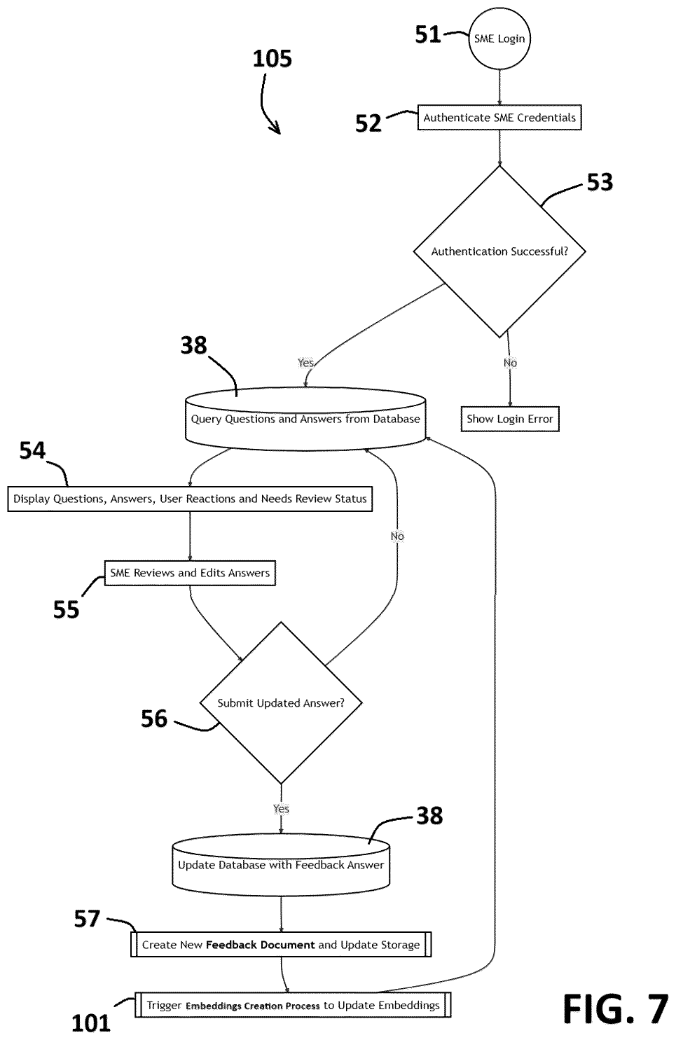

If feedback is present for the user query as at query symbol 36, the process follows the process feedback track as at subroutine symbol 42. The system reviews a conversation history from the relational database 38 and formats the conversation history for context as at process symbol 50 in view of the user query and the presence of feedback. A feedback flow sequence from the subject matter expert via a feedback user interface is generally depicted in FIG. 7 detailing a feedback user interface process 105. The Feedback User Interface is the user interface used by a subject matter expert to review and alter answers or precedent contextualized responses to questions asked by users. The feedback user interface process 105 begins with a subject matter expert login 51 that first authenticates the credentials of the subject matter expert as at process symbol 52. If authentication is successful as at query symbol 53, user queries, Bot Answer System (BAS) answers, user feedback/reactions and ‘needs review’ status from the relational database 38 are displayed as at process symbol 54. The subject matter expert is enabled to review user queries, BAS answers, including precedent contextual responses, user feedback/reactions and ‘needs review’ status indicators from the relational database 38 as at process symbol 55.

The subject matter expert may then review user queries and further edit answers as needed as at process symbol 55. If no edits are required, the subject matter expert may also review user feedback/reactions or needs review items and provide feedback as needed. The subject matter expert has the ability to update both the original user query and the generated answer before submitting changes/edits. If updated answers or subject matter feedback is provided as at query symbol 56, the relational database 38 is updated with feedback or updated answer(s) whereafter a new or revised feedback document is created and the vector database 13 is updated as at subroutine symbol 57 by way of the embedding creation process 101 once a final review and approval of the answer is achieved.

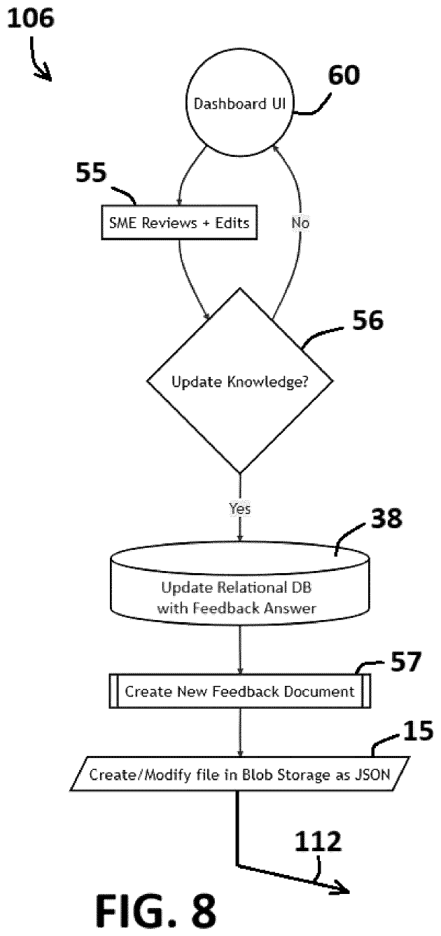

A dashboard user interface process is further summarized in FIG. 8 showing the dashboard user interface flow or process 106 initiating at a dashboard user interface 60. The dashboard user interface may also be referred to as the question user interface and is employed to collect questions/answers and reactions from users asking questions of a GenAI bot of the bot answer system. In some applications, the question user interface is also used by a subject matter expert to enter new or revised questions and answers and in this context may be referred to as a dashboard user interface.

After accessing the dashboard user interface 60, the subject matter expert may review content and make any necessary edits as at process symbol 55. If feedback is provided for the purpose of updating the knowledge base as at query symbol 56, the relational database 38 is updated with feedback or an updated answer and a new or revised feedback document is created and either a new file is created in blob storage or existing files are modified in blob storage in JSON format as at input/output symbol 15, the required preliminary step before initiating the embedding creation process 101 otherwise depicted in FIG. 2. Once the new or revised feedback document has been saved in blob storage in JSON format, the process redirects as at arrow 102 to the embedding creation process 101 through which the revised feedback document is vectorized into embeddings and stored or saved within the vector database 13.

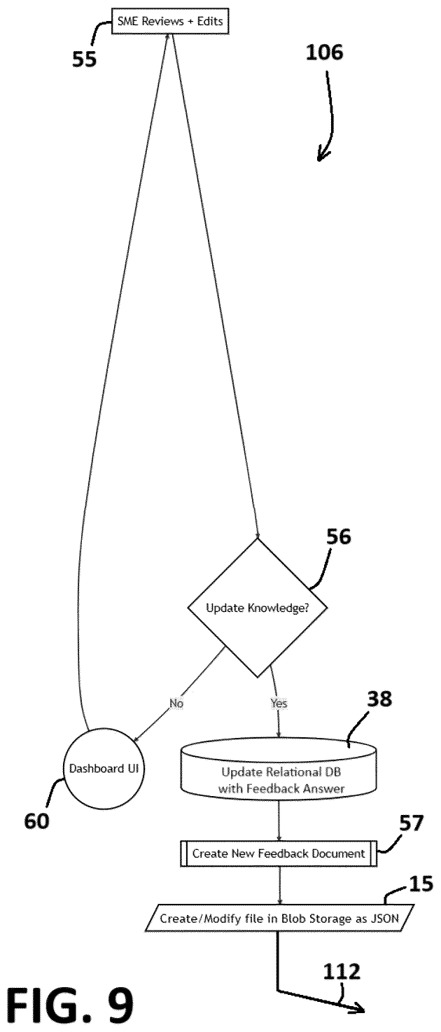

The dashboard user interface process 106 is reconfigured and presented in FIG. 9 for further consideration. The reader will note the SME Reviews and Edits process symbol 55 has been placed in a superior position on the page with the dashboard user interface initialization 60 positioned at an inferior position on the page. Once it is determined that the knowledge base should be updated as at query symbol 56, the relational database 38 is updated with the feedback answer and the revised feedback document is created as at subroutine symbol 57 whereafter the revised feedback document file is stored or saved in blob storage in JSON format for redirecting into the embedding creation process 101 as at arrow 112. The embedding creation process 101 according to the presently disclosed subject matter derives from bifurcated and converging data flows, the first of which is directed thereto from the first partition or side via the source document sequencing or process 100 as at arrow 111 and the second of which is directed thereto from the second partition or side via the feedback document sequencing or process 106.

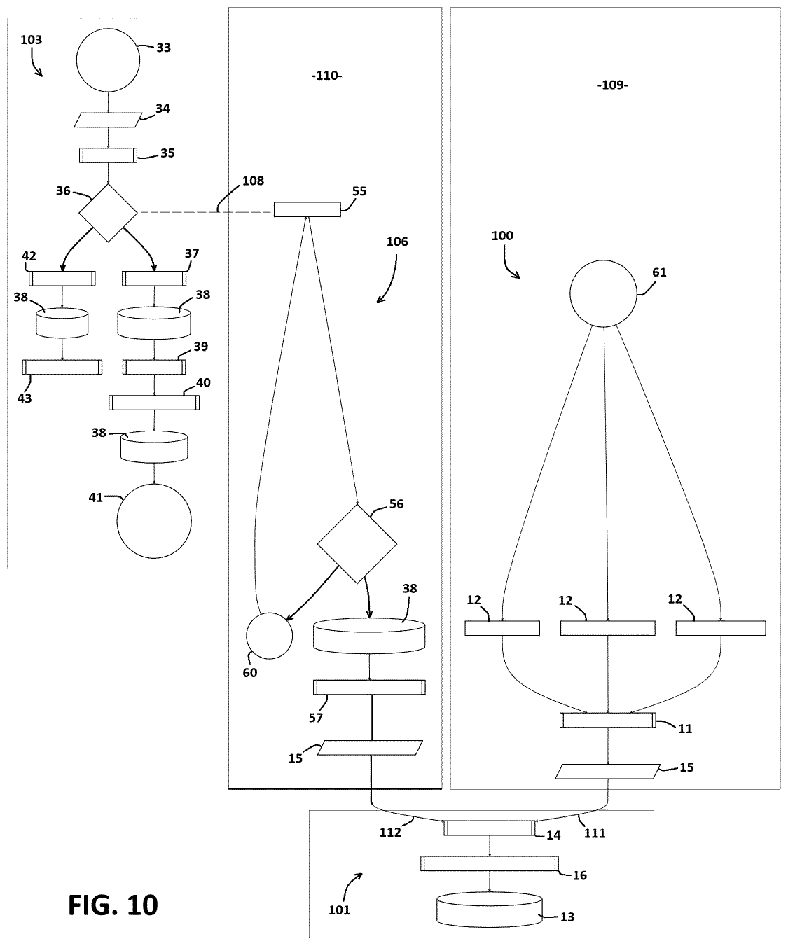

Referring back and comparatively referencing FIGS. 1 and 2, the reader will note that once source documents 11 are stored or saved in blob storage in JSON format from the partitioned initial or updated source document load sequence or process 100, the system redirects to the embedding creation process as at arrow 111. It will be recalled the knowledge base as stored within the vector database 13 is compiled by way of convergent data flows, including initial and updated source document retrieval flows from a first partition or side of the system and feedback document flows from a second partition or side of the system. The first partition or side of the system is referenced at 109 in FIG. 10 and the second partition or side of the system is referenced at 110 in FIG. 10. Referencing FIG. 10, the reader will consider the initial and updated source document retrieval flow from the first partition or side 109 of the system and feedback document flows from the second partition or side 110 of the system, which are directed into the embedding creation process 101 respectively at arrows 111 and 112.

Comparatively referencing FIGS. 9 and 10, the SME Reviews and Edits process symbol 55 is positioned in general alignment as at dashed line 108 with the feedback query symbol 36 of the simplified user query process 103 for querying whether feedback is present. The firstly partitioned source flow 109 and the secondly partitioned feedback flow 110 are positioned in side-by-side relation in FIG. 10 to demonstrate converging data flows into the embedding creation process 101, respectively via arrows 111 and 112. Accordingly, in some applications it will be understood the system and method for expert-assisted generative AI prompt response adaptation according to the presently disclosed subject matter may be said to comprise a bifurcated data flow system that converges into a terminal vector database 13 for enhancing reliable and accurate data retrieval thereby bolstering accuracy of answers to user queries. Exemplary data flow sessions are summarized below to aid the reader.

A source document 11 is first created or updated via the data extraction process 100 as generally and diagrammatically depicted in FIGS. 1, 3A, 3B and 4. Next, the embedding creation process 101 vectorizes the source document 11 and then stores the metadata and creation date into the vector database 13 as diagrammatically depicted in FIG. 2. Referencing FIGS. 3A and 3B, a user asks a question or poses a user query (e.g. a tax question) within the question user interface. The user then sends the user query to the Bot Answer System or BAS. The Bot Answer System rephrases the question using a GPT model which is then used as the user query for generating an answer or query response to the user query.

The system then searches the vector database 13 for the top “N” most relevant source documents 11. In some applications, the most relevant source documents 11 may derive from the most recent timestamps and updates, and thus recency of updates may control or play a factor in the determined relevance. Then the system sends the question prompt and the related documents to the GPT model for summarization. The question and response is saved to the relational database 38 and the answer is then returned to the question user interface for display and consumption by the user. In some applications, the user may then designate the answer as “positive” or “negative” based on its accuracy. The positive/negative reaction is sent back to the Bot Answer System to be stored in the relational database 38.

If the user flags the answer as correct or has a positive reaction, no further processing is required. If the answer is flagged as incorrect or has a negative reaction, or if the subject matter expert simply wishes to revise the answer or provide feedback in real-time, the subject matter expert may revise the user query and resubmit the user query or provide feedback to the bot answer system. The revised user query or subject matter expert feedback is reviewed by the bot answer system and a revised answer is provided by the bot answer system.

A supplemental or further review by the same subject matter expert or a supervisory subject matter expert may then follow. In this regard, the reader will recall a Subject Matter Expert Champion or SME-C may access the system via the feedback user interface for finally reviewing and approving a final answer to be stored in the vector database 13. In this regard, the question and answer cycle according to the presently disclosed subject matter is subject to at least two review sessions in some applications. If the revised bot answer system response is correct, the revised response is saved or stored in the knowledge base of the vector database 13. If the SME-revised response is incorrect, the answer may again be revised by the subject matter expert or supervisory subject matter expert or SME-C and the knowledge base within the vector database 13 may be updated accordingly.

When the subject matter expert accesses the question user interface for the purpose of submitting a revised user query, the data extraction process 100 polls for recent questions and answers. Source documents and feedback documents are first both stored in blob storage as JSON files and convergently directed into the vector database 13 via the embedding creation process 101. The embedding creation process 101 ensures new content is available for future questions. This allows immediate feedback by subject matter experts to be directed into the bot answer system so that wrong answers can be quickly corrected by a human subject matter expert in real-time.

When the subject matter expert accesses the feedback user interface, the feedback user interface lists all questions, answers, and positive or negative feedback. The subject matter expert may select a question and then can update the original question and the generated answer. Once the subject matter expert or subject matter expert champion approves changes and a final, correct answer, the feedback user interface process generates a feedback document which is stored as a structured JSON file in blob storage. From that point the embedding creation system or process runs to pull out the metadata and embeddings and stores these in the vector database 13. This process provides no feedback into the bot answering system until the subject matter expert or experts finally approve the modified response.

To illustrate an exemplary question-answer session via the system according to the presently disclosed subject matter the reader is directed to FIG. 11. Referencing FIG. 11, the reader will consider a question user interface 120 or a sample Question and Answer screen according to the system of the presently disclosed subject matter within a tax context or environment. A user of the system first asks a question or poses a user query 121 via interaction with a chatbot upon the question user interface 120. The chatbot generates an AI-generated response as at 122. The AI-generated response is queried for accuracy and correctness. If the chatbot response is correct, the process terminates unless a Subject Matter Expert or SME revises either the question or answer.

If the chatbot response is flagged as incorrect, the SME provides feedback. The chatbot then processes the feedback and provides a revised response whereafter the same or a supervisory SME may further review the revised response to the user query to determine whether the revised response is accurate and correct. If the revised response is correct, the system updates a chatbot knowledge base stored within a vector database 13. If the revised response is incorrect, the same or supervisory SME further adjusts the response to ensure correctness whereafter the chatbot knowledge base within the vector database 13 is updated. Should a user thereafter ask the same question or pose the same user query, the chatbot responds with a corrected answer deriving from the updated chatbot knowledge base whereafter the process terminates.

When a chatbot response is flagged as incorrect, system support agents (the SMEs) provide feedback to the chatbot by tagging the chatbot and selecting “feedback.” In the example depicted in FIG. 11, the chatbot has provided an incorrect answer to the question of whether a software user can schedule an electronic debit for more than what the software calculates is the tax owed by the user. The chatbot says “yes” when the actual answer is “no.” The sample support agent or subject matter expert Jane Smith 123 enters a corrected answer (“Support Bot feedback” 124). The system then processes the corrected answer feedback and the generative model may both modify the question (i.e. provides a “Contextual Question” 125) and provide a revised answer (i.e., a “Contextual Answer from the Bot” 126). If the revised response is correct, the system updates a chatbot knowledge base stored within a vector database 13.

If the revised response or Contextual Answer from the Bot 126 is incorrect, the same or supervisory SME further adjusts the response to ensure correctness. It should be noted that while these specifications discuss one cycle of supervisory review, the system may include additional cycles of review in which each corrected answer feedback portion may modify both the Contextual Question 125 for outputting and a further refined Contextual Answer from the Bot 126. Once a fully correct and acceptable answer is provided, the chatbot knowledge base within the vector database 13 is updated. Should a user thereafter ask the same question or pose the same user query, the chatbot responds with a corrected answer deriving from the updated chatbot knowledge base and the process terminates.

It will be recalled the user may also provide feedback in the form of a positive or negative reaction. In some applications, the system may include more complex reaction systems to allow the user to provide feedback over a wider range of reaction to the content, all of which are reviewable by the SME. In this regard, the user is directed to the reaction panel 127 positioned intermediate the user query portion 121 and the support bot answer portion 122. By tagging a select reaction button, the support bot answer portion 122 is flagged and the feedback user interface is updated for possible review by the SME as discussed hereinabove. Further, in some applications, the support bot may also return one or more reference articles as at 128 in its initial support bot answer 122.

While the above descriptions contain much specificity, this specificity should not be construed as limitations on the scope of the presently disclosed subject matter, but rather as an exemplification thereof. For example, according to a first aspect of the presently disclosed subject matter, a system for expert-assisted generative AI prompt response adaptation within a computer-populated environment is contemplated. In some embodiments, the system may be said to comprise a user interface, a bot answer system, a generative model, and a feedback integration system. The user interface enables a user to pose and send a user query or question and display an answer or query response to the user query. The bot answer system is configured to retrieve relevant context in response to the user query. The generative model is configured to provide the answer upon the user interface based on retrieved relevant context data in response to the user query. Central to the practice of the first aspect is the feedback integration system. The feedback integration system is configured to provide subject matter expert feedback on at least one of the user query and the answer. The subject matter expert feedback is directable into the system through a subject matter expert review system, the feedback from which ensures continual improvement of a knowledge base.

According to another aspect of the presently disclosed subject matter provides a system for expert-assisted generative AI prompt response adaptation within a computer-populated environment. The system may be said to essentially comprise a firstly partitioned source document retrieval system configured to retrieve and periodically update source documents in response to a user query; a generative model configured to provide an answer based on the retrieved and periodically updated source documents in response to the user query, the answer being stored in a first file format; a secondly partitioned feedback integration system configured to provide a subject matter expert feedback document in connection with at least one of the user query and the answer, the subject matter expert feedback document being stored in the first file format; and an embedding creation system configured to vectorize the answer and the subject matter expert feedback document and store embeddings therefrom within a vector database thereby providing a convergent knowledge base from which the answer can be returned to the user in response to the user query.

According to another aspect of the presently disclosed subject matter provides a method for expert-assisted generative AI prompt response adaptation within a computer-populated environment. The method may be said to essentially comprise the steps of retrieving source documentation via a data extraction process of a bot answer system; storing the source documentation in a first file format in a relational database or in a physical file storage; creating a feedback document in response to at least one of a user query and a query response within the bot answer system; storing the feedback document in the first file format in the relational database or the physical file storage; vectorizing the source documentation and the feedback document via an embedding creation process; storing embeddings from the embedding creation process in a vector database thereby providing a vectorized knowledge base; and providing the query response to the user query via a generative model based on the vectorized knowledge base.

In other words, although the system and method according to the present invention has been described by reference to a number of different features and elements, it is not intended that the novel forms and functions be limited thereby, but that modifications thereof are intended to be included as falling within the broad scope and spirit of the foregoing disclosures, the appended drawings, and the following claims.

What is claimed is:

1. A system for expert-assisted generative AI prompt response adaptation within a computer-populated environment, the system comprising:
a user interface, the user interface for enabling a user to pose and send a user query and display an answer to the user query;
a bot answer system, the bot answer system being configured to retrieve relevant context in response to the user query;
a generative model configured to provide the answer upon the question user interface based on retrieved relevant context data in response to the user query; and
a feedback integration system configured to provide subject matter expert feedback on at least one of the user query and the answer, the subject matter expert feedback for ensuring continual improvement of a knowledge base.

2. The system according to claim 1, wherein the bot answer system and the feedback integration system are partitioned from one another and configured to direct partitioned data flows through a convergent embedding creation process, the embedding creation process being configured to vectorize the partitioned data flows and store embeddings in a vector database supporting the knowledge base.

3. The system according to claim 2, wherein the vector database leverages metadata-driven retrieval, prioritizing source documents based on similarity, recency of updates, and data source, the vector database thereby ensuring the knowledge base is continually updated with relevant and reliable information in support of the answer.

4. The system according to claim 3, wherein the feedback integration system is configured to provide subject matter expert feedback in real-time based on at least one of the user query and the answer.

5. The system according to claim 4, wherein the feedback integration system is configured to provide supervisory subject matter expert review and final approval before the partitioned data flows are vectorized and the embeddings are stored in the vector database for supporting the knowledge base.

6. The system according to claim 4 comprising a user feedback mechanism for enabling the user to provide reactionary feedback in response to the answer, the reactionary feedback being reviewable and answerable by a Subject Matter Expert (SME) via an SME feedback document, the SME feedback document providing a basis for at least a contextualized query response.

7. The system according to claim 6, wherein a feedback user interface is configured to enable at least one subject matter expert to review at least one of the user query, the answer, and the reactionary feedback and provide the subject matter expert feedback in response to any one of the user query, the answer, and the reactionary feedback before the generative model provides the contextual query response upon the user interface.

8. The system according to claim 7, wherein the bot answer system is based on and characterized by a retrieval-augmented generation architecture and the generative model is characterized by a generative pretrained transformer.

9. A system for expert-assisted generative AI prompt response adaptation within a computer-populated environment, the system comprising:
a firstly partitioned source document retrieval system configured to retrieve and periodically update source documents in response to a user query;
a generative model configured to provide an answer based on the retrieved and periodically updated source documents in response to the user query, the answer being stored in a first file format;
a secondly partitioned feedback integration system configured to provide a subject matter expert feedback document in connection with at least one of the user query and the answer, the subject matter expert feedback document being stored in the first file format; and
an embedding creation system configured to vectorize the answer and the subject matter expert feedback document and store embeddings therefrom within a vector database thereby providing a convergent knowledge base from which the answer can be returned to the user in response to the user query.

10. The system according to claim 9, wherein the vector database leverages metadata-driven retrieval, prioritizing source documentation based on similarity, recency of updates, and data source, the vector database thereby ensuring the convergent knowledge base is continually updated with relevant and reliable information to generate and return the answer.

11. The system according to claim 9, wherein the feedback integration system is configured to provide subject matter expert feedback in real-time based on at least one of the user query and the answer.

12. The system according to claim 11, wherein the feedback integration system is configured to provide supervisory subject matter expert review and final approval before the partitioned data flows are vectorized and the embeddings are stored in the vector database for supporting the convergent knowledge base.

13. The system according to claim 12 comprising a user feedback mechanism for enabling the user to provide reactionary feedback in response to the answer, the reactionary feedback being reviewable and answerable within the feedback integration system for providing a contextualized query response in real-time.

14. The system according to claim 13, wherein a feedback user interface is configured to enable at least one subject matter expert to review at least one of the user query, the answer, and the reactionary feedback and provide the subject matter expert feedback in response to any one of the user query, the answer, and the reactionary feedback.

15. A method for expert-assisted generative AI prompt response adaptation within a computer-populated environment, the method comprising the steps of:
retrieving source documentation via a data extraction process of a bot answer system;
storing the source documentation in a first file format in a physical file storage;
creating a feedback document in response to at least one of a user query and a query response within the bot answer system;
storing the feedback document in the first file format in the physical file storage;
vectorizing the source documentation and the feedback document via an embedding creation process;
storing embeddings from the embedding creation process in a vector database thereby providing a vectorized knowledge base; and
providing the query response to the user query via a generative model based on the vectorized knowledge base.

16. The method according to claim 15 comprising the step of storing metadata corresponding to the source documentation within the vector database, the vector database thereby leveraging metadata-driven retrieval and prioritizing source documentation based on similarity, recency of updates, and data source.

17. The method according to claim 16 comprising the steps of:
providing user feedback in response to the query response;
reviewing at least one of the user feedback, the user query and the query response in real-time; and
revising at least one of the user query and the query response in real-time thereby providing a revised feedback before the step of vectorizing the source documentation and the feedback document via an embedding creation process.

18. The method according to claim 17 comprising the steps of:
storing the revised feedback upon a final approval in the first file format in the physical file storage;
vectorizing a finally approved revised feedback via the embedding creation process;
storing embeddings from the finally approved revised feedback in the vector database thereby providing an updated knowledge base; and
providing a contextualized query response via the generative model based on the updated knowledge base.

19. The method according to claim 18 comprising the steps of:
providing a listing of reviewable content upon a feedback user interface, the feedback user interface being configured to enable a Subject Matter Expert to review any one of the user query, the query response, the user feedback and a precedent contextualized response;
revising at least one of the user query, the query response and the precedent contextualized response thereby providing the revised feedback;
storing the finally approved revised feedback in the first file format in the physical file storage;
vectorizing the finally approved revised feedback via the embedding creation process;
storing embeddings from the revised feedback in the vector database thereby providing an updated knowledge base; and
providing a final contextualized query response via the generative model based on the updated knowledge base.

20. The method according to claim 18 comprising the steps of:
reviewing a precedent contextualized response before outputting a final answer upon a user interface;
revising at least one of the user query and the precedent contextualized response thereby providing the revised feedback;
storing the revised feedback in the first file format in the physical storage;
vectorizing the revised feedback via the embedding creation process;
storing embeddings from the revised feedback in the vector database thereby providing an updated knowledge base; and
providing a final contextualized query response via the generative model based on the updated knowledge base.
